(19) United States
(12) Patent Application Publication
(10) Pub. No.: US 2025/0272463 A1
(43) Pub. Date: Aug. 28, 2025

(54) Systems and Methods for Dynamically Adjusting Clock Skips to Mitigate Voltage Droop

(71) Applicant: Altera Corporation, San Jose, CA (US)

(72) Inventors: Guang Chen, Fremont, CA (US); Archanna Srinivasan, San Jose, CA (US); Yi Peng, Newark, CA (US); Gregory Steinke, Saratoga, CA (US)

(21) Appl. No.: 19/092,839

(22) Filed: Mar. 27, 2025

(51) Int. Cl. G06F 30/31; G06F 30/327

(52) U.S. Cl. CPC G06F 30/31; G06F 30/327

(57) ABSTRACT

To mitigate voltage droop while reducing the power and space consumed on the board and reducing switching activity, a clock skipping scheme may be implemented for an FPGA. The clock skipping scheme may be implemented in the FPGA design via an Electronic Design Automation (EDA) tool. The EDA tool may define clock skipping cycles based on customer needs for current ramp up speed (e.g., for an inrush current or an operating current) and clock frequency. The EDA tool may adjust clock skipping based on a power target and/or usage conditions of a user software design. In addition to mitigating voltage droop and reducing space consumed on the board and power consumed by the FPGA, the clock skipping scheme may maintain a base clock frequency, enable timing closure at the base clock frequency, and alleviate the need to reclose timing during clock skipping operations.

### BACKGROUND

The present disclosure relates generally to integrated circuit devices, such as programmable logic devices. More particularly, the present disclosure relates to decreasing voltage droop for a power rail within an integrated circuit device.

Programmable logic devices (PLDs), a class of integrated circuit, may be programmed to perform a wide variety of operations. It may be desirable to reduce voltage droop—and thus maintain stable voltage supply—on the power rails of the PLDs. A change in activity on the PLD may cause the system current draw to change, which may induce power supply noise. Power supply noise may be regulated by a specification for the PLD to ensure proper performance. Changes in activity may result in a change in current (di/dt) on the power rails of the PLD. Greater di/dt may cause greater voltage droop.

### BRIEF DESCRIPTION OF THE DRAWINGS

Various aspects of this disclosure may be better understood upon reading the following detailed description and upon reference to the drawings in which:

FIG. 1 is a block diagram of a system used to program an integrated circuit device;

FIG. 2 is a block diagram of an example integrated circuit device that may be programmed with a system design;

FIG. 3 illustrates multiple clock skipping schemes that may be implemented on the integrated circuit device of FIG. 2;

FIG. 4 is a flowchart of a method for setting and dynamically adjusting a clock skipping scheme on the integrated circuit device of FIG. 2;

FIG. 5 is a flowchart of a method for gradually and/or progressively ramping up current in the integrated circuit device by progressively changing the clock skipping scheme implemented on the integrated circuit device;

FIG. 6 illustrates the power savings that may be obtained via a dynamic or progressive clock skipping scheme;

FIG. 7 is a plot that illustrates the voltage drop characteristics of a device utilizing dynamic clock skipping and the voltage drop characteristics of a device maintaining full clock utilization; and

FIG. 8 is an integrated circuit system on which the dynamic or progressive clock skipping schemes may be carried out.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

The present disclosure describes systems and techniques related to decreasing voltage droop on power rails of an integrated circuit, such as a PLD (e.g.,. a field-programmable gate array (FPGA)) while maintaining performance, reducing power consumption, and reducing design costs. Maintaining stable voltage supply is desirable for FPGA system performance. However, as FPGA activity changes, current drawn by the system may change, and the system current draw change may result in power supply noise. The power supply noise may be regulated within silicon specification to ensure silicon performance. In some instances, voltage droop may be mitigated by adding additional silicon, additional packaging, and/or additional decoupling capacitors to the printed circuit board (PCB). However, additional silicon, packaging, and decoupling capacitors may consume excessive space on the board. Additionally or alternatively, di/dt may be reduced by turning on only part of the circuit at a time, which may increase FPGA design complexity. The di/dt may also be reduced via frequency hopping. However, frequency hopping may result in additional timing closure for different frequencies, which increases FPGA design complexity.

To mitigate voltage droop while reducing the power and space consumed on the board and reducing switching activity, a clock skipping scheme may be implemented for the FPGA. The clock skipping scheme may be implemented in the FPGA design via an Electronic Design Automation (EDA) tool. The EDA tool may define clock skipping cycles based on customer specifications for current ramp up speed (e.g., for an inrush current or an operating current) and clock frequency. The EDA tool may adjust clock skipping based on a power target and/or usage conditions of a user software design. In addition to mitigating voltage droop and reducing space consumed on the board and power consumed by the FPGA, the clock skipping scheme may maintain a base clock frequency, enable timing closure at the base clock frequency, and alleviate the need to reclose timing during clock skipping operations.

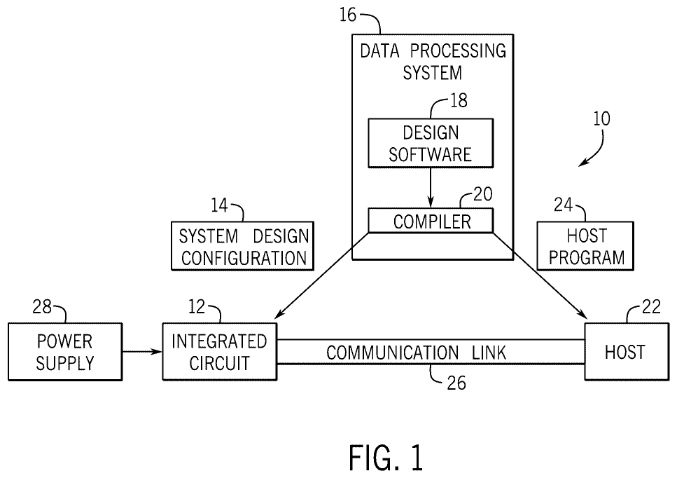

FIG. 1 illustrates a block diagram of a system 10 that may be used to program such an integrated circuit device 12, such as an FPGA (e.g., Agilex™, Stratix®, Arria®, MAX®, or Cyclone® devices by Altera® Corporation), with a system design using a system design configuration 14. Note that, while this disclosure largely refers to the integrated circuit device 12 as being a programmable logic device, such as an FPGA, in some embodiments, the integrated circuit device 12 may also be a one-time programmable device or structured application specific integrated circuit (ASIC), such as an Intel® eASIC™ device by Intel® Corporation. In other examples, the integrated circuit device 12 may be any suitable integrated circuit that is manufactured to have a particular system design with circuitry to perform desired data processing operations. The integrated circuit device 12 may be a single monolithic integrated circuit or a multi-die system of integrated circuits. The integrated circuit device 12 may include a single integrated circuit, multiple integrated circuits in a package, or multiple integrated circuits in multiple packages communicating remotely (e.g., via wires or traces) and may be referred to as an integrated circuit device or an integrated circuit system whether formed from a single integrated circuit or multiple integrated circuits in a package. The integrated circuit device 12 may be electrically coupled to a power supply 28. The power supply 28 may include a power regulator such as a voltage regulator, and may be an internal power supply or an external power supply.

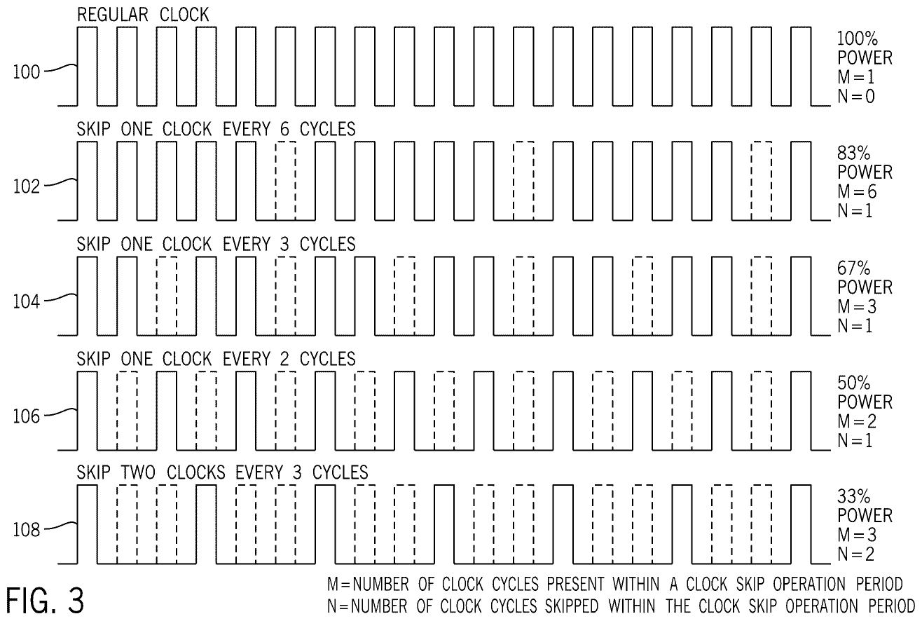

A designer may desire to implement the system design 14 (sometimes referred to as a circuit design or configuration) to perform a wide variety of possible operations on the integrated circuit device 12. In some cases, the designer may specify a high-level program to be implemented, such as an OPENCL® program that may enable the designer to more efficiently and easily provide programming instructions to configure a set of programmable logic cells for the integrated circuit device 12 without specific knowledge of low-level hardware description languages (e.g., Verilog, very high-speed integrated circuit hardware description language (VHDL)). For example, since OPENCL® is quite similar to other high-level programming languages, such as C++, designers of programmable logic familiar with such programming languages may have a reduced learning curve than designers that are required to learn unfamiliar low-level hardware description languages to implement new functionalities in the integrated circuit device 12. The system design 14 may include one or more dynamic clock skipping schemes with various levels of clock skipping to achieve a variety of power levels, as will be explained in greater detail with respect to FIGS. 3-8 below. The clock skipping schemes may supplement or replace dynamic voltage and frequency scaling (DVFS) schemes, as the dynamic clock skipping schemes may enable the integrated circuit device 12 to maintain a consistent clock frequency while reducing power consumption and voltage drop.

In a configuration mode of the integrated circuit device 12, a designer may use a data processing system 16 (e.g., a computer including a data processing system having a processor and memory or storage) to implement high-level designs (e.g., a system user design) using design software 18 (e.g., executable instructions stored in a tangible, non-transitory, computer-readable medium such as the memory or storage of the data processing system 16), such as a version of INTEL® QUARTUS® by INTEL CORPORATION or other electronic design automation (EDA) tool. The data processing system 16 may use the design software 18 and a compiler 20 to convert the high-level program into a lower-level description (e.g., a configuration program, a bitstream) as the system design configuration 14. The compiler 20 may provide machine-readable instructions representative of the high-level program to a host 22 and the system design configuration 14 to the integrated circuit device 12. The design software 18 and/or the compiler 20 may include an EDA tool that may generate and load a clock skipping scheme into the integrated circuit device 12, as will be discussed in greater detail below.

Additionally or alternatively, the host 22 running the host program 24 may control or implement the system design configuration 14 onto the integrated circuit device 12. For example, the host 22 may communicate instructions from the host program 24 to the integrated circuit device 12 via a communications link 26 that may include, for example, direct memory access (DMA) communications or peripheral component interconnect express (PCIe) communications. The designer may use the design software 18 to generate and/or to specify a low-level program, using low-level tools such as the low-level hardware description languages described above. Further, in some embodiments, the system 10 may be implemented without a separate host 22 or host program 24. Thus, embodiments described herein are intended to be illustrative and not limiting.

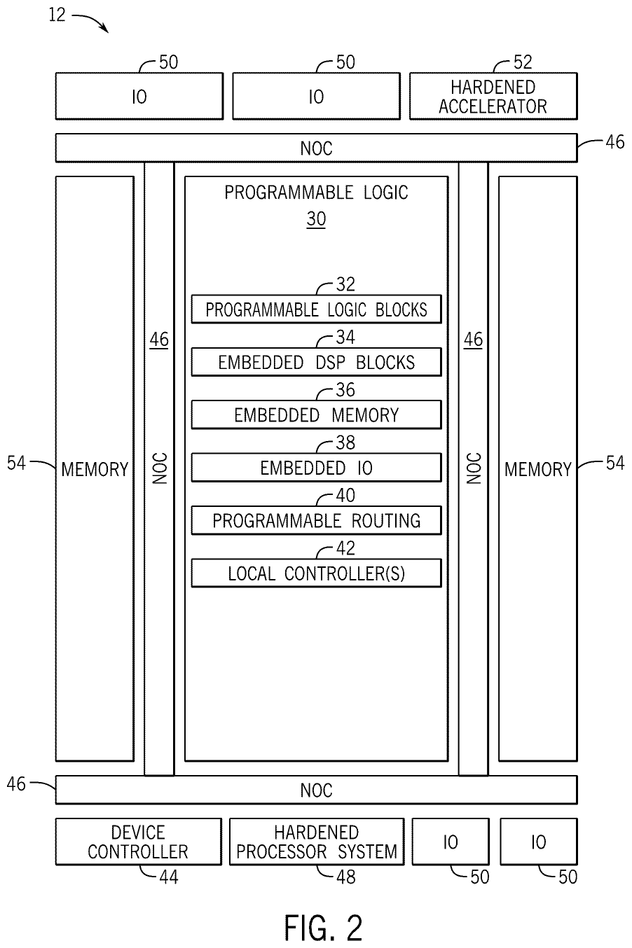

The integrated circuit device 12 may take any suitable form that may implement the system design configuration 14. In one example shown in FIG. 2, the integrated circuit device 12 may include programmable logic 30, which include a two-dimensional array of many different functional blocks, such as programmable logic blocks 32, embedded digital signal processing (DSP) blocks 34, embedded memory blocks 36, and embedded input-output blocks 38. In many cases, there may be rows or columns of these functional blocks that may be programmably connected to one another using programmable routing 40.

The programmable logic blocks 32 may be programmed to implement a wide variety of logic circuitry. The programmable logic blocks 32 may include a number of adaptive logic modules (ALMs), which may take the form of lookup tables (LUTs) that can be programmed to implement a logic truth table, effectively enabling any the programmable logic blocks 32 to implement any desired logic circuitry when configured with the system design configuration 14. The programmable logic blocks 32 and are sometimes referred to as logic array blocks (LABs) or configurable logic blocks (CLBs).

The embedded DSP blocks 34, embedded memory blocks 36, and embedded IO blocks 38 may be distributed around the programmable logic blocks 32. For example, there may be several columns of programmable logic blocks 32 for every column of DSP blocks 34, column of embedded memory blocks 36, or column of embedded IO blocks 38. The embedded DSP blocks 34 may include “hardened” circuits that are specialized to efficiently perform certain arithmetic operations. This is in contrast to “soft logic” circuits that may perform the same functions by programming the programmable logic blocks 32, but which may not be as efficient as the hardened circuits of the DSP blocks 34. The embedded memory blocks 36 may include dedicated local memory (e.g., blocks of 20 kB, blocks of 1 MB). The embedded IO blocks 38 may allow for certain inter-die or inter-package communication. The embedded DSP blocks 34, embedded memory blocks 36, and embedded IO blocks 38 may be accessible to the programmable logic blocks 32 using the programmable routing 40.

The various functional blocks of the programmable logic 30 may be grouped into programmable regions, sometimes referred to as logic sectors, that may be individually managed and configured by corresponding local controllers 42 (e.g., sometimes referred to as Local Sector Managers (LSMs)). The grouping of the programmable logic 30 resources on the integrated circuit device 12 into logic sectors, logic array blocks, logic elements, or adaptive logic modules is merely illustrative. In general, the integrated circuit device 12 may include functional logic blocks of any suitable size and type, which may be organized in accordance with any suitable logic resource hierarchy. Indeed, there may be other functional blocks (e.g., other embedded application specific integrated circuit (ASIC) blocks) than those shown in FIG. 2.

Before continuing, it may be noted that the programmable logic 30 circuitry of the integrated circuit device 12 may be controlled by programmable memory elements sometimes referred to as configuration random access memory (CRAM). Memory elements may be loaded with configuration data (also called programming data or a configuration bitstream) that represents the system design configuration 14. Once loaded, the memory elements may provide a corresponding static control signal that controls the operation of an associated functional block. In one scenario, the outputs of the loaded memory elements are applied to the gates of metal-oxide-semiconductor transistors in a functional block to turn certain transistors on or off and thereby configure the logic in the functional block including the routing paths. Programmable logic circuit elements that may be controlled in this way include parts of multiplexers (e.g., multiplexers used for forming routing paths in interconnect circuits), look-up tables, logic arrays, AND, OR, NAND, and NOR logic gates, pass gates, and the like. The configuration memory elements may use any suitable volatile and/or non-volatile memory structures such as random-access-memory (RAM) cells, fuses, antifuses, programmable read-only-memory (ROM) memory cells, mask-programmed, laser-programmed structures, or combinations of structures such as these.

A device controller 44, sometimes referred to as a secure device manager (SDM), may manage the operation of the integrated circuit device 12. The device controller 44 may include any suitable logic circuitry to control and/or program the programmable logic 30 or other elements of the integrated circuit device 12. For example, the device controller 44 may include a processor (e.g., an x86 processor or a reduced instruction set computer (RISC) processor, such as an Advanced RISC Machine (ARM) processor or a RISC-V processor) that executes instructions stored on any suitable tangible, non-transitory, machine-readable media (e.g., memory or storage). Additionally or alternatively, the device controller 44 may include a hardware finite state machine (FSM). The device controller 44 may provide other functions, such as serving as a platform for virtual machines that may manage the operation of the integrated circuit device 12.

A network-on-chip (NOC) 46 may connect the various elements of the integrated circuit device 12. The NOC 46 may provide rapid, packetized communication to and from the programmable logic 30 and other blocks, such as a hardened processor system 48, high-speed input-output (IO) blocks 50, a hardened accelerator 52, and local device memory 54. The integrated circuit device 12 may include the hardened processor system 48 when the integrated circuit device 12 takes the form of a system-on-chip (SOC). The hardened processor system 48 may include a hardened processor (e.g., an x86 processor or a reduced instruction set computer (RISC) processor, such as an Advanced RISC Machine (ARM) processor or a RISC-V processor) that may act as a host machine on the integrated circuit device 12. The high-speed IO blocks 50 may enable communication using any suitable communication protocol(s) with other devices outside of the integrated circuit device 12, such as a separate memory device. The hardened accelerator 52 may include any hardened application-specific integrated circuitry (ASIC) logic to perform a desired acceleration function. For example, the hardened accelerator 52 may include hardened circuitry to perform cryptographic or media encoding or decoding. The memory 54 may provide local device memory (e.g., cache) that may be readily accessible by the programmable logic 30.

As mentioned above, to mitigate voltage droop on the integrated circuit device 12 while reducing the power and space consumed on the board and reducing switching activity, a clock skipping scheme may be implemented for the integrated circuit device 12 (e.g., an FPGA). The clock skipping scheme may be implemented in the FPGA design via an EDA tool (e.g., INTEL® QUARTUS®). FIG. 3 illustrates a regular clock scheme 100 in comparison to multiple clock skipping schemes 102, 104, 106, and 108 that are provided by way of example that may be implemented on the integrated circuit 12. In practice, any suitable clock skipping scheme with any suitable relationship of clock pulses to skipped clock pulses may be used. Each example is associated with a clock cycle factor (sometimes referred to as an M factor) that may indicate the number of clock cycles present within a clock skip operation period. Each example is also associated with a clock skipping factor (sometimes referred to as an N factor) that indicate the number of clock cycles skipped within the clock skipping operation period.

The regular clock scheme 100 is associated with a clock cycle factor (e.g., M factor) of 1 and a clock skipping factor (e.g., N factor) of 0, meaning that the regular clock scheme 100 performs 100% of the clock cycles on the integrated circuit 12, includes no clock skips, and thus operates at full power. The clock skipping scheme 102 is associated with a clock cycle factor of 6 and a clock skipping factor of 1, meaning that there are 6 clock cycles in a clock skip operation period, and 1 clock cycle is skipped within the clock skip operation period. That is, as may be observed, the clock skipping scheme 102 skips one clock cycle every six cycles. Accordingly, the clock skipping scheme 102 operates at 83% of full power. The clock skipping scheme 104 is associated with a clock cycle factor of 3 and a clock skipping factor of 1, and thus skips 1 cycle every 3 cycles of a clock skip operation period. Accordingly, the clock skipping scheme 104 operates at 67% of full power. The clock skipping scheme 106 is associated with a clock cycle factor of two and a clock skipping factor of 1, and thus skips 1 cycle every 2 cycles of a clock skip operation period. Accordingly, the clock skipping scheme 106 operates at 50% power. The clock skipping scheme 108 is associated with a clock cycle factor of 3 and a clock skipping factor of 2, and thus skips 2 cycle every 3 cycles. Accordingly, the clock skipping scheme 108 operates at 33% of full power. It should be appreciated that the current (e.g., the inrush current or the operating current) may be greatest at the regular clock scheme 100 and the least at the clock skipping scheme 108. Consequently, the voltage drop associated with the regular clock scheme 100 may be the greatest (due to the greatest current) while the voltage drop associated with clock skipping scheme 108 may be the least (due to the lowest current). It should be noted that the clock skipping schemes illustrated in FIG. 3 are merely illustrative, and any appropriate clock skipping scheme may be utilized (e.g., skipping one clock cycle out of every 30 cycles, or more, skipping one clock cycle out of every 20 cycles or more, skipping one clock cycle out of every 10 cycles or more, skipping one clock cycle out of every nine clock cycles or more, skipping one clock cycle out of every five clock cycles or more, and so on.)

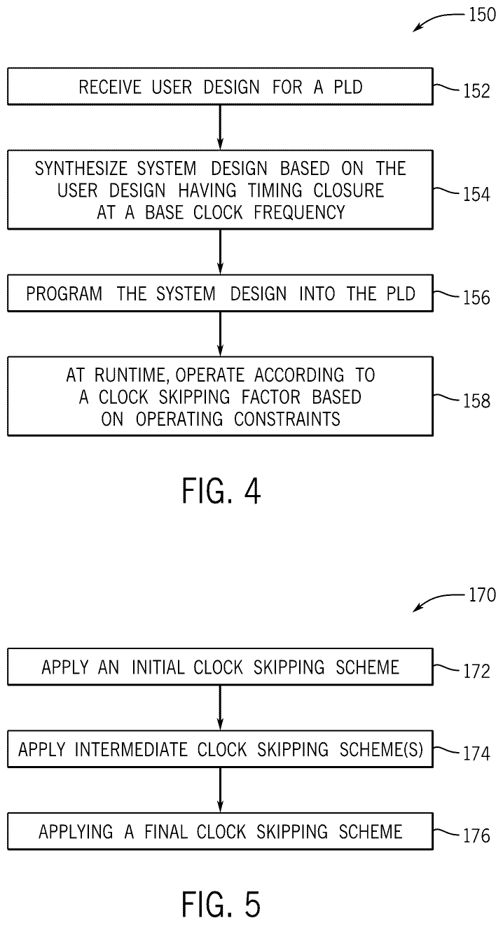

FIG. 4 is a flowchart of a method 150 for setting and dynamically adjusting a clock skipping scheme of the integrated circuit device 12. The method may be performed by the hardened processor system 48 or one or more controllers (e.g., the device controller 44) of the integrated circuit device 12. In process block 152, the hardened processor system 48 may receive a user design (e.g., from a computer used by a designer or programmer). The user design may include operating constraints such as a target current ramp-up speed, a target base clock frequency, usage conditions, and any other appropriate parameter desired by the user. In process block 154, the hardened processor system 48 may cause an EDA tool to synthesize the system design 14 based on the user design having timing closure at a base clock frequency. In process block 156, the EDA tool may program the system design 14 into the integrated circuit device 12. In process block 158, the integrated circuit device 12 may operate, at runtime, according to a clock cycle factor (e.g., the M factor) and a clock skipping factor (e.g., the N factor) based on the operating constraints.

For example, based on the operating constraints and/or other parameters indicated by the user design, the EDA tool may determine a target (e.g., desired) inrush current to be supplied to the integrated circuit device 12 at startup of the integrated circuit device 12 that may reduce or minimize the voltage drop associated with the startup of the integrated circuit 12. The voltage drop may be referred to in some instances as IR drop based on Ohm's law, which states that voltage (V) is equal to current (I) multiplied by resistance (R), or V=IR. Further, in a system with constant power (P), power is equal to the voltage multiplied by the current, or P=VI. Accordingly, if the integrated circuit 12 receives a constant power supply, a large inrush current may result in a proportional voltage reduction or voltage (e.g., IR) drop. As the integrated circuit device 12 may operate most efficiently and predictably at a given voltage level, a large inrush current may cause that voltage to fluctuate (e.g., drop), causing the integrated circuit device 12 to operate at an undesirable voltage level. This may result in inefficiency of or damage to the integrated circuit device 12.

With the foregoing in mind, the EDA tool may determine the target inrush current such that voltage drop is reduced or minimized. The target inrush current may be achieved by adjusting a clock skipping scheme of the integrated circuit 12 based on the target current ramp-up speed, the target base clock frequency, the usage conditions, and/or any other appropriate parameter. For example, if the EDA tool provides the clock skipping scheme 102 to the integrated circuit device 12, the integrated circuit device 12 may skip one clock cycle every six cycles, operating at 83% of full power. The EDA tool may determine whether the first current provided by the first clock skipping scheme violates any operating constraints or parameters of the user design. The EDA tool may determine whether the first current violates the operating constraints or parameters based on whether the integrated circuit device 12 misses the target current ramp-up speed or the target base clock frequency or fails to meet desired usage conditions during execution of a workload. If the first clock skipping scheme does not violate the user design specification, the integrated circuit device 12 may continue using the first clock skipping scheme 102.

However, if the clock skipping scheme 102 violates the operating constraints or parameters, the EDA tool may determine a second clock skipping scheme to provide a second current, and update the integrated circuit device 12 such that the integrated circuit 12 operates on the second clock skipping scheme. The EDA tool may either increase or decrease the frequency of the clock skipping based on whether the integrated circuit device 12 went above or below its target operating characteristics. For example, if the integrated circuit device 12 exceeded a target current ramp-up speed or the target base clock frequency, the second clock skipping frequency may include a lower-power clock skipping scheme such as the clock skipping schemes 104, 106, or 108 (or any other appropriate clock skipping scheme with a power below 83% of full power). However, if the current ramp-up speed or the target base clock frequency of the integrated circuit 12 fell below the target current ramp-up speed or the target base clock frequency, then the second clock skipping frequency may include a higher-power clock skipping scheme such as the clock skipping scheme 100 (or any other appropriate clock skipping scheme with a power above 83% of full power). This dynamic adjustment of the clock skipping scheme may iteratively repeated until the target operating characteristics or parameters of the integrated circuit device 12 are met.

In some instances, it may be beneficial to initialize the integrated circuit device with a first, lower-power clock skipping scheme and gradually ramp up to a final, higher-power clock skipping scheme. FIG. 5 is a flowchart of a method 170 for gradually or progressively ramping up clock skipping schemes of the integrated circuit device 12. In process block 172 the EDA tool may apply an initial clock skipping scheme to the integrated circuit device 172. The EDA tool may apply, at a first time T1, a lower-power clock skipping scheme, such as the clock skipping scheme 108 discussed with respect to FIG. 3, wherein the integrated circuit device 12 may skip two clock cycles every three cycles. In process block 174, the EDA tool may apply one or more intermediate clock skipping schemes. For example, the EDA tool may incrementally adjust the clock skipping scheme such that subsequent schemes have fewer clock skips and thus greater current draw. The EDA tool may cause the integrated circuit device to apply a second clock skipping scheme such as the clock skipping scheme 106 at a time T2, and apply a third clock skipping scheme such as the clock skipping scheme 104 at a time T3, and so on until the regular clock scheme of 100 (and full power for the integrated circuit device 12) is reached.

In process block 176, the EDA tool may apply a final clock skipping scheme. The final clock skipping scheme may be the regular clock scheme 100 or it may be a lower-power clock skipping scheme (e.g., 102). In some instances, the EDA tool may apply only two clock skipping schemes, having an initial clock skipping scheme (e.g., 108) and a final scheme (e.g., 100). Moreover, the EDA tool may determine which clock schemes to apply sequentially based on operating conditions or parameters of the integrated circuit device 12. In this manner, the method 170 of FIG. 5 enables the integrated circuit device 12 to gradually and dynamically ramp up to a target inrush current.

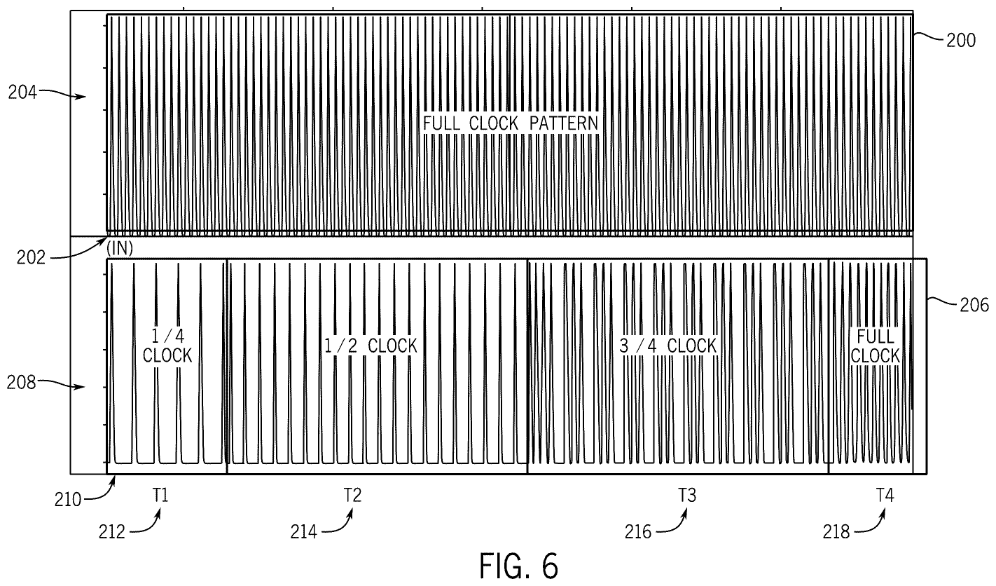

FIG. 6 illustrates an example of power savings that may be obtained via a dynamic or progressive clock skipping scheme as described in FIGS. 3-5 in comparison to a scheme in which full power is used without any clock skipping. A plot 200 illustrates power drawn by an integrated circuit device 12 that does not have a dynamic clock skipping scheme. The plot 200 has an x-axis 202 illustrating time and a y-axis 204 illustrating current. As may be appreciated, over the course of the operation of the integrated circuit device 12 without a clock skipping scheme, the integrated circuit device 12 will draw a large amount of power (as compared to an integrated circuit device 12 utilizing a clock skipping scheme) due to the constant pulling of max current at each clock cycle. A plot 206 shows the operation of an integrated circuit device 12 that implements a dynamic clock skipping scheme as illustrated in FIG. 3 above. The plot 206 includes an x-axis 208 illustrating time and a y-axis 210 illustrating current. As may be observed, at time T1, the integrated circuit device 12 is programmed with a system design 14 that operates according to a clock cycle factor and clock skipping factor that provides a ¼ clock skipping scheme 212 (e.g., a clock cycle factor M of 4 and a clock skipping factor N of 3). That is, the clock skipping scheme at time T1 skips 3 clock cycles every 4 clock cycles. At time T2, the integrated circuit device 12 is programmed with a system design 14 that operates according to a clock cycle factor that provides a ½ clock skipping scheme 214 (e.g., M=2, N=1). That is, the clock skipping scheme at time T2 skips one clock cycle every two cycles. At time T3, the integrated circuit device 12 is programmed with a system design 14 that operates according to a clock cycle factor that provides a ¾ clock skipping scheme 216 (e.g., M=4, N=1). That is, the clock skipping scheme at time T3 skips one clock cycle every four clock cycles. Finally, at time T4, the integrated circuit device 12 is programmed with a system design 14 that operates according to a clock cycle factor that provides a full clock cycle, meaning that no clock cycles are skipped and T4 operates on a regular clock scheme 218 (e.g., M=1, N=0). As may be appreciated, because of the clock skipping schemes at times T1-T3, the integrated circuit device 12 represented by the plot 206 may consume less power and lower the inrush current (and consequently, the voltage drop) as compared to the integrated circuit device 12 represented by the plot 200.

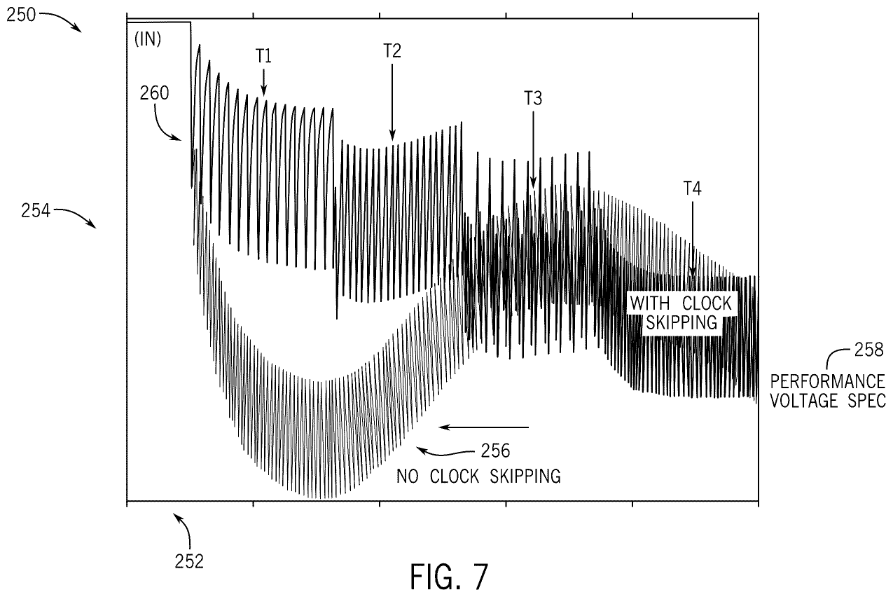

FIG. 7 is a plot 250 that illustrates the voltage drop characteristics of a device utilizing dynamic clock skipping and the voltage drop characteristics of a device maintaining full clock utilization. The plot 250 includes an x-axis 252 representing time and a y-axis 254 representing voltage. The plot 250 includes a first waveform 256 that represents an integrated circuit device 12 with no clock skipping scheme (e.g., such as is illustrated by the plot 200 described with respect to FIG. 6). As may be observed, at startup of the integrated circuit device 12, the inrush current may cause the voltage to drop significantly below a desired (e.g., optimal) voltage level 258.

The plot 250 includes a waveform 260 that represents an integrated circuit device 12 with a dynamic or progressive clock skipping scheme (e.g., such as is illustrated by the plot 206 described with respect to FIG. 6). As may be observed, the waveform 260 (e.g., the voltage of the integrated circuit device 12) is gradually walked down as current gradually increases. The waveform 260 may be operating based on the clock skipping schemes illustrated in the plot 206. That is, the ¼ clock skipping scheme 212 at time T1 of FIG. 6 may result in the voltage output at T1 of FIG. 7. Likewise, the ½ clock skipping scheme 214 at time T2 may result in the voltage output at T2 of FIG. 7, the ¾ clock skipping scheme 216 may result in the voltage output at T3, and the regular clocking scheme 218 may result in the voltage output at T4. Accordingly, it may be observed that a dynamic or progressive clock skipping scheme that gradually or ramps up current intake may mitigate or eliminate undesirable voltage drop for the integrated circuit device 12.

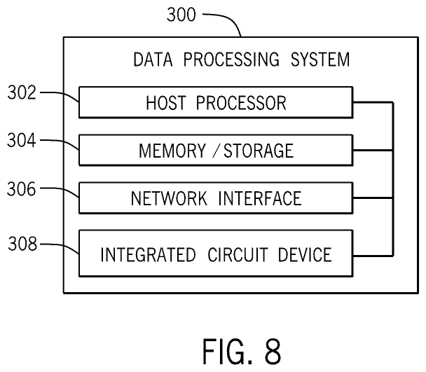

The processes discussed above may be carried out on the integrated circuit system 12, which may be a component included in a data processing system, such as a data processing system 300, shown in FIG. 8. The data processing system 300 may include the integrated circuit device 12 (e.g., a programmable logic device), a host processor 302, memory and/or storage circuitry 304, and a network interface 306. The data processing system 300 may include more or fewer components (e.g., electronic display, user interface structures, application specific integrated circuits (ASICs)). The host processor 302 may include any of the foregoing processors that may manage a data processing request for the data processing system 300 (e.g., to perform encryption, decryption, machine learning, video processing, voice recognition, image recognition, data compression, database search ranking, bioinformatics, network security pattern identification, spatial navigation, cryptocurrency operations, or the like). The memory and/or storage circuitry 504 may include random access memory (RAM), read-only memory (ROM), one or more hard drives, flash memory, or the like. The memory and/or storage circuitry 304 may hold data to be processed by the data processing system 300. In some cases, the memory and/or storage circuitry 504 may also store configuration programs (e.g., bitstreams, mapping function) for programming the integrated circuit device 12. The network interface 306 may allow the data processing system 300 to communicate with other electronic devices. The data processing system 300 may include several different packages or may be contained within a single package on a single package substrate. For example, components of the data processing system 300 may be located on several different packages at one location (e.g., a data center) or multiple locations. For instance, components of the data processing system 300 may be located in separate geographic locations or areas, such as cities, states, or countries.

The data processing system 300 may be part of a data center that processes a variety of different requests. For instance, the data processing system 300 may receive a data processing request via the network interface 306 to perform encryption, decryption, machine learning, video processing, voice recognition, image recognition, data compression, database search ranking, bioinformatics, network security pattern identification, spatial navigation, digital signal processing, or other specialized tasks.

The techniques and methods described herein may be applied with other types of integrated circuit systems. For example, the programmable routing bridge described herein may be used with central processing units (CPUs), graphics cards, hard drives, or other components.

While the embodiments set forth in the present disclosure may be susceptible to various modifications and alternative forms, specific embodiments have been shown by way of example in the drawings and have been described in detail herein. However, the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform] ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

EXAMPLE EMBODIMENT 1. A tangible, non-transitory computer-readable medium comprising computer-readable instructions that when executed cause one or more processors to:
receive a user design for an integrated circuit; and
synthesize a system design operable with a plurality of clock skipping schemes, wherein at least one clock skipping scheme of the plurality of clock skipping schemes comprises a normal clock operation where no clock cycles are skipped, and at least one clock skipping scheme of the plurality of clock skipping schemes comprises an operation wherein at least one clock cycle is skipped based at least in part on a first clock cycle factor indicating a number of clock cycles within a clock skip operation period.

EXAMPLE EMBODIMENT 2. The tangible, non-transitory computer-readable medium comprising computer-readable instructions of example embodiment 1, that when executed cause the one or more processors to:
determine a current to be drawn by the integrated circuit based on the user design; and
determine a first clock skipping scheme based on one or more operating constraints and the first clock cycle factor.

EXAMPLE EMBODIMENT 3. The tangible, non-transitory computer-readable medium comprising computer-readable instructions of example embodiment 2, wherein the current comprises an inrush current associated with a startup state of the integrated circuit.

EXAMPLE EMBODIMENT 4. The tangible, non-transitory computer-readable medium comprising computer-readable instructions of example embodiment 2, wherein the one or more operating constraints comprise a ramp-up speed, a clock frequency, or both.

EXAMPLE EMBODIMENT 5. The tangible, non-transitory computer-readable medium comprising computer-readable instructions of example embodiment 2, that when executed cause the one or more processors to:
update the first clock skipping scheme to a second clock skipping scheme based on the current violating a user design specification; and
operate the integrated circuit according to the second clock skipping scheme.

EXAMPLE EMBODIMENT 6. The tangible, non-transitory computer-readable medium comprising computer-readable instructions of example embodiment 5, wherein the integrated circuit comprises a field-programmable gate array (FPGA).

EXAMPLE EMBODIMENT 7. The tangible, non-transitory computer-readable medium comprising computer-readable instructions of example embodiment 6, wherein the first clock skipping scheme is updated to the second clock skipping scheme during partial reconfiguration of the FPGA.

EXAMPLE EMBODIMENT 8. The tangible, non-transitory computer-readable medium comprising computer-readable instructions of example embodiment 5, wherein the first clock skipping scheme corresponds to the first clock cycle factor and the second clock skipping scheme corresponds to a second clock cycle factor, wherein the second clock cycle factor is greater than the first clock cycle factor.

EXAMPLE EMBODIMENT 9. A data processing system comprising:
a memory comprising an electronic design automation (EDA) tool; and
processing circuitry configured to execute the EDA tool on an integrated circuit, wherein executing the EDA tool comprises:
operating the integrated circuit according to an initial clock skipping scheme at a first time;
operating the integrated circuit according to an intermediate clock skipping scheme at a second time; and
operating the integrated circuit according to a final clock skipping scheme at a third time.

EXAMPLE EMBODIMENT 10. The data processing system of example embodiment 9, wherein the EDA tool, when executed by the processing circuitry, is configured to determine the initial clock skipping scheme, the intermediate clock skipping scheme, and the final clock skipping scheme based on operating constraints indicated by a user design.

EXAMPLE EMBODIMENT 11. The data processing system of example embodiment 10, wherein the operating constraints comprise a ramp-up speed, a clock frequency, or both.

EXAMPLE EMBODIMENT 12. The data processing system of example embodiment 10, wherein EDA tool, when executed by the processing circuitry, is configured to determine the initial clock skipping scheme according to a first clock cycle factor, the intermediate clock skipping scheme according to a second clock cycle factor, and the final clock skipping scheme according to a third clock cycle factor.

EXAMPLE EMBODIMENT 13. The data processing system of example embodiment 12, wherein the third clock cycle factor is less than the second clock cycle factor, and the second clock cycle factor is less than the first clock cycle factor.

EXAMPLE EMBODIMENT 14. The data processing system of example embodiment 9, wherein the integrated circuit is updated from the initial clock skipping scheme to the intermediate clock skipping scheme during partial reconfiguration.

EXAMPLE EMBODIMENT 15. The data processing system of example embodiment 9, wherein the integrated circuit is updated from the intermediate clock skipping scheme to the final clock skipping scheme during partial reconfiguration.

EXAMPLE EMBODIMENT 16. A tangible, non-transitory computer-readable medium comprising computer-readable instructions that when executed cause one or more processors to:
receive a user design for an integrated circuit device;
synthesize a system design based on the user design having a timing closure at a base clock frequency;
program the system design into the integrated circuit device; and
at runtime of the integrated circuit device, operate according to a first clock cycle factor and a first clock skipping factor based on operating constraints indicated by the user design.

EXAMPLE EMBODIMENT 17. The tangible, non-transitory, computer-readable medium of example embodiment 16, wherein the instructions when executed cause the one or more processors to:
determine a current drawn by the integrated circuit device based on the user design;
generate a first clock skipping scheme based on the operating constraints and the first clock cycle factor and the first clock skipping factor; and
cause the integrated circuit device to operate according to the first clock skipping scheme.

EXAMPLE EMBODIMENT 18. The tangible, non-transitory, computer-readable medium of example embodiment 16, wherein the instructions when executed cause the one or more processors to:
update the first clock skipping scheme to a second clock skipping scheme based on a current associated with the first clock skipping scheme violating a user design specification; and
cause the integrated circuit device to operate according to the second clock skipping scheme.

EXAMPLE EMBODIMENT 19. The tangible, non-transitory, computer-readable medium of example embodiment 18, wherein the first clock skipping scheme is updated to the second clock skipping scheme during partial reconfiguration of the integrated circuit device.

EXAMPLE EMBODIMENT 20. The tangible, non-transitory, computer-readable medium of example embodiment 18, wherein the first clock skipping scheme corresponds to the first clock cycle factor and the first clock skipping factor and the second clock skipping scheme corresponds to a second clock cycle factor and a second clock skipping factor, and at least the second clock cycle factor is different than the first clock cycle factor.

What is claimed is:

1. A tangible, non-transitory computer-readable medium comprising computer-readable instructions that when executed cause one or more processors to:
receive a user design for an integrated circuit; and
synthesize a system design operable with a plurality of clock skipping schemes, wherein at least one clock skipping scheme of the plurality of clock skipping schemes comprises a normal clock operation where no clock cycles are skipped, and at least one clock skipping scheme of the plurality of clock skipping schemes comprises an operation wherein at least one clock cycle is skipped based at least in part on a first clock cycle factor indicating a number of clock cycles within a clock skip operation period.

2. The tangible, non-transitory computer-readable medium comprising computer-readable instructions of claim 1, that when executed cause the one or more processors to:
determine a current to be drawn by the integrated circuit based on the user design; and
determine a first clock skipping scheme based on one or more operating constraints and the first clock cycle factor.

3. The tangible, non-transitory computer-readable medium comprising computer-readable instructions of claim 2, wherein the current comprises an inrush current associated with a startup state of the integrated circuit.

4. The tangible, non-transitory computer-readable medium comprising computer-readable instructions of claim 2, wherein the one or more operating constraints comprise a ramp-up speed, a clock frequency, or both.

5. The tangible, non-transitory computer-readable medium comprising computer-readable instructions of claim 2, that when executed cause the one or more processors to:
update the first clock skipping scheme to a second clock skipping scheme based on the current violating a user design specification; and
operate the integrated circuit according to the second clock skipping scheme.

6. The tangible, non-transitory computer-readable medium comprising computer-readable instructions of claim 5, wherein the integrated circuit comprises a field-programmable gate array (FPGA).

7. The tangible, non-transitory computer-readable medium comprising computer-readable instructions of claim 6, wherein the first clock skipping scheme is updated to the second clock skipping scheme during partial reconfiguration of the FPGA.

8. The tangible, non-transitory computer-readable medium comprising computer-readable instructions of claim 5, wherein the first clock skipping scheme corresponds to the first clock cycle factor and the second clock skipping scheme corresponds to a second clock cycle factor, wherein the second clock cycle factor is greater than the first clock cycle factor.

9. A data processing system comprising:
a memory comprising an electronic design automation (EDA) tool; and
processing circuitry configured to execute the EDA tool on an integrated circuit, wherein executing the EDA tool comprises:
operating the integrated circuit according to an initial clock skipping scheme at a first time;
operating the integrated circuit according to an intermediate clock skipping scheme at a second time; and
operating the integrated circuit according to a final clock skipping scheme at a third time.

10. The data processing system of claim 9, wherein the EDA tool, when executed by the processing circuitry, is configured to determine the initial clock skipping scheme, the intermediate clock skipping scheme, and the final clock skipping scheme based on operating constraints indicated by a user design.

11. The data processing system of claim 10, wherein the operating constraints comprise a ramp-up speed, a clock frequency, or both.

12. The data processing system of claim 10, wherein EDA tool, when executed by the processing circuitry, is configured to determine the initial clock skipping scheme according to a first clock cycle factor, the intermediate clock skipping scheme according to a second clock cycle factor, and the final clock skipping scheme according to a third clock cycle factor.

13. The data processing system of claim 12, wherein the third clock cycle factor is less than the second clock cycle factor, and the second clock cycle factor is less than the first clock cycle factor.

14. The data processing system of claim 9, wherein the integrated circuit is updated from the initial clock skipping scheme to the intermediate clock skipping scheme during partial reconfiguration.

15. The data processing system of claim 9, wherein the integrated circuit is updated from the intermediate clock skipping scheme to the final clock skipping scheme during partial reconfiguration.

16. A tangible, non-transitory computer-readable medium comprising computer-readable instructions that when executed cause one or more processors to:
receive a user design for an integrated circuit device;
synthesize a system design based on the user design having a timing closure at a base clock frequency;
program the system design into the integrated circuit device; and
at runtime of the integrated circuit device, operate according to a first clock cycle factor and a first clock skipping factor based on operating constraints indicated by the user design.

17. The tangible, non-transitory, computer-readable medium of claim 16, wherein the instructions when executed cause the one or more processors to:
determine a current drawn by the integrated circuit device based on the user design;
generate a first clock skipping scheme based on the operating constraints and the first clock cycle factor and the first clock skipping factor; and
cause the integrated circuit device to operate according to the first clock skipping scheme.

18. The tangible, non-transitory, computer-readable medium of claim 16, wherein the instructions when executed cause the one or more processors to:
update the first clock skipping scheme to a second clock skipping scheme based on a current associated with the first clock skipping scheme violating a user design specification; and
cause the integrated circuit device to operate according to the second clock skipping scheme.

19. The tangible, non-transitory, computer-readable medium of claim 18, wherein the first clock skipping scheme is updated to the second clock skipping scheme during partial reconfiguration of the integrated circuit device.

20. The tangible, non-transitory, computer-readable medium of claim 18, wherein the first clock skipping scheme corresponds to the first clock cycle factor and the first clock skipping factor and the second clock skipping scheme corresponds to a second clock cycle factor and a second clock skipping factor, and at least the second clock cycle factor is different than the first clock cycle factor.
